(19) United States
(12) Patent Application Publication
(10) Pub. No.: US 2016/0119706 A1
(43) Pub. Date: Apr. 28, 2016

(54) EARRING WITH ENHANCED FUNCTIONALITY

(71) Applicants: Abigail L. Dubois, Brooklyn, NY (US); Lawrence H. Dubois, Danbury, CT (US)

(72) Inventors: Abigail L. Dubois, Brooklyn, NY (US); Lawrence H. Dubois, Danbury, CT (US)

(21) Appl. No.: 14/881,209

(22) Filed: Oct. 13, 2015

Related U.S. Application Data
(60) Provisional application No. 62/067,603, filed on Oct. 23, 2014.

(51) Int. Cl. H04R 1/10; A44C 7/00

(52) U.S. Cl. CPC H04R 1/1033; A44C 7/00

(57) ABSTRACT

An apparatus for securing an earpiece having a cable, the apparatus comprising: an earring having an attachment portion and a base portion, wherein the base portion has a channel that runs a length of the base portion to receive a portion of an earpiece, such as the cable.

This application claims priority to provisional patent application 62/067,603 filed Oct. 23, 2014 and entitled, “Earring with enhanced functionality,” the entire contents of which are incorporated herein by reference.

The present invention relates generally to an apparatus for affixing a portion of an earpiece, or a similar device, proximate to a body. More particularly, the invention relates to an earring or part of an earring with enhanced functionality such that it aids in the retention of earpieces (for example, the cable of an earbud) and related devices in, on, or near the ear of the wearer despite movement of the head.

### DESCRIPTION OF BACKGROUND ART

With the advent of small, portable music players, mobile telephones, multimedia and gaming devices, the use of corded earpieces, earphones, earbuds, earpods, headphones, headsets, in-ear monitors, canalphones, hearing aids, etc. (hereinafter generally referred to as “earpieces”) are ubiquitous throughout the world. Because they are lightweight, easily inserted into the ear, are generally low-cost, and provide good-quality sound, the most popular earpieces in use today are earbuds (also referred to as in-ear headphones) which sit inside the concha of the ear. In order for the earpiece to be effective, however, it must be in or on (or at the very least near) the ear. Motion of the head during, for example, walking, running, dancing, climbing stairs, swimming, exercising, etc. may cause unwanted movement of the earpiece relative to the ear. Movement of the earpiece may be exacerbated by inadvertent touching or pulling on the cable and even the weight of the cable may help lever the earpiece out of the ear. Perfume, lotion, sweat, etc. may also loosen the seating of the earpiece in the ear. This results in earpieces that either partially or completely detach from the ear and thus loss of auditory quality.

Aspects of the issues noted above have been addressed previously by, for example, Yang in U.S. Patent Application 2007/0104345 which discloses the use of a removable ear hanger. This ear hanger attaches to the earpiece directly and wraps around the external portion of the ear to retain the earpiece in position. While such a concept may be effective for holding the earpiece on or in the ear, it makes insertion and removal of the earpiece(s) more challenging, may decrease the comfort of the earpiece (for example, while wearing eye glasses), and adds substantially to the bulk of what is supposed to be a compact device, thus making storage more difficult.

Chinese patent CN 201781605 U discloses an earring that is semi-permanently attached to an earpiece perpendicular to the concha of the ear so that the earpiece is away from the ear. This type of mounting makes it very difficult to add or remove the earpiece and puts all of the weight of the earpiece (including the cable) on the earring (and thus the ear) adding discomfort to the wearer.

Orzel et al. in U.S. Patent Application 2013/0177193 disclose the use of a securing device that fits within the concha cavity of the ear in order to reduce the risk of dislodgement of the earpiece. Again, while such a device may be effective at securing the earpiece in the ear, it too makes insertion and removal of the earpiece more difficult and alters the wearing experience.

More recently earpieces have become “fashion statements” and, in order to enhance their aesthetic appeal, are now available in many colors, shapes, and sizes. In order to augment the ornamental nature of earpieces further, Parng in U.S. Patent Application 2013/0036597 and Yoo in U.S. Patent Application 2014/0146798, for example, disclose the adornment of earpieces by means of the attachment of jewelry. This adds to the weight of the earpiece (potentially increasing wearer fatigue) and changes its center of gravity (and thus may cause it to dislodge from the ear more readily).

Finally, if one wants to remove an earpiece from the ear, for example, in order to hear external sounds more clearly, one must hold the wired earpiece(s), wrap them around the back of the neck, or place them inside a purse, pocket, etc. This additional issue has been addressed partially, for example, by Harper in U.S. Pat. No. 7,436,974 wherein each portion of the two earpieces of a set of earphones may be connected by, for example, a magnetic mechanism and worn around the neck. This too adds to the weight of each earpiece (potentially causing it to dislodge more readily). Furthermore, it may necessitate the use of two hands to remove and connect the earpieces and certainly requires both earpieces to be removed in order to operate properly.

Accordingly there is a need for a device to secure earpieces on, in, or near the ear that overcomes the above-noted shortcomings. These and other features, aspects and advantages of the present invention will become better understood with reference to the following description and claims.

### SUMMARY OF THE INVENTION

The present invention relates generally to an earring or part of an earring with enhanced functionality such that it aids in the retention of earpieces.

According to one aspect of the present invention, an apparatus for securing an earpiece having a cable, the apparatus comprising: an earring having an attachment portion and a base portion, wherein the base portion has a channel that runs a length of the base portion to receive a portion of an earpiece.

According to another aspect of the present invention, an apparatus for securing an earpiece having a cable is provided, the apparatus comprising: an earring having an attachment portion and a base portion having at least one extension, wherein the extension receives a portion of a cable of an earpiece to align the cable to run a length of the base portion that is away from the attachment portion.

According to another aspect of the present invention, an apparatus for securing an earpiece having a cable is provided, the apparatus comprising: an earring having a piercing stud portion, an earring backing that removably attaches to the piercing stud portion and a base portion, wherein the earring backing has a first circular side with an opening to receive a portion of a cable of an earpiece therein, a second circular side and a bore between the first circular side and second circular side to attach the earring backing to the piercing stud portion.

According to another aspect of the present invention, an apparatus for securing an earpiece having a cable is provided, the apparatus comprising: an earring having a piercing stud portion, an earring backing that removably attaches to the piercing stud portion and a base portion; and a cable receiving portion with an opening to receive a portion of a cable of an earpiece therein and a bore to attach the cable receiving portion to the piercing stud portion between the base portion and the earring backing.

According to another aspect of the present invention, an apparatus for securing an earpiece having a cable is provided, the apparatus comprising: an earring having an attachment portion and a base portion, wherein the base portion has at least two raised portions that create a center opening that runs a length of the base portion to receive a portion of an earpiece.

These and other features, aspects and advantages of the present invention will become better understood with reference to the following description and claims.

### BRIEF DESCRIPTION OF THE DRAWINGS

FIG. 1A is a side view of a user wearing an earring with enhanced functionality. FIG. 1B shows the earring (on the ear) and earpiece (in the ear) functionality with the cable (wire) from the earpiece attached to the earring. FIG. 1C shows one embodiment of the invention wherein the cable from the earpiece goes through a semi-circular channel in the side of a stud earring designed for pierced ears.

FIG. 2 is a perspective view of a pierced stud earring demonstrating multiple positions for a channel to hold the cable from an earpiece including front, side, and back of the earring. Slots may be straight or curved (bent). Note that the surface of the curved channel is textured to enhance the grip onto the earpiece cable.

FIG. 3A demonstrates one embodiment of the invention in a stud earring wherein a semi-circular channel for the cable is internal to the earring body while 3B demonstrates a second embodiment wherein a semi-closed round channel for the cable is external to the body of the earring. The latter channel is segmented.

FIG. 4 shows multiple different embodiments of the invention for the attachment of a cable (wire) to an earring. These include one or more posts or pins in which to contain the cable (4A), offset posts or pins (4B), a strap and snap (4C), movable clamps (4D), a short post with flat top (4E), and a cleat (4F).

FIG. 5 demonstrates two different embodiments of the invention showing both earring and earpiece functionality. FIG. 5A is a “crawling” earring more rigidly attached to the ear than the cuff earring in FIG. 5B. In 5A the attachment is directly to the cable (wire) guide of an earpiece while in 5B the connection is to the cable from the earpiece. FIG. 5C and 5D are two views of a barbell earring attached to the cable guide of an earpiece. Because the barbell can rotate, the earring is “self-aligning” with respect to the angle of the cable guide.

FIG. 6 shows multiple embodiments of the invention for users with pierced ears each with channels for the attachment of a cable from an earpiece: 6A a faux gauge earring, 6B a gauge earring, 6C an ear wire, 6D a hoop earring, 6E a lever-back earring, 6F a linked earring, 6G an ear jacket earring, 6H a reversible earring with decorative channels in both the front and back parts, 6I a chandelier earring with connection points either on the base, on the detachable “charms,” or both, and 6J an industrial earring.

FIG. 7 demonstrates one embodiment of the invention with a square channel in multiple types of earrings including: 7A a pierced and clip earring, 7B a clip-on earring, 7C a magnetic earring, and 7D a stick-on earring.

FIG. 8A demonstrates an additional embodiment of the invention where a slot to hold a cable from an earpiece is embedded into the backing of an earring for a pierced ear. In FIGS. 8B and 8D an earpiece cable support is separate from the earring and the earring back and in FIG. 8C a support for the cable from an earpiece slides onto or clips onto the wire of an ear wire-style earring.

FIG. 9A is a photograph of six embodiments of the invention. FIGS. 9B, 9C, and 9D are a series of photographs showing how the earring is used by the wearer. These include a nail head stud (9B), a heart stud (9C), and a pyramid stud (9D) with the cable from the earpiece connected through a channel in the front (9B and 9C) or side (9D) of the earring.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

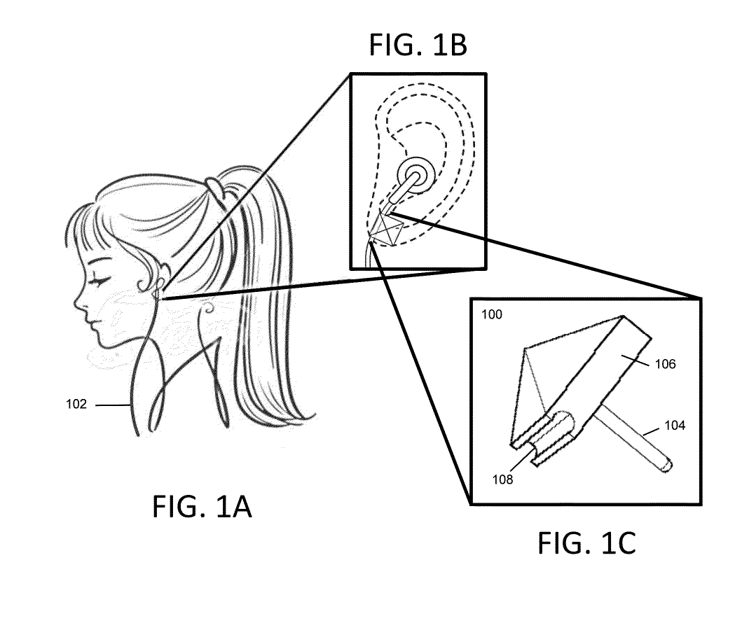

The present invention relates generally to an apparatus for affixing a portion of an earpiece, or a similar device, proximate to a body. More particularly, an earring or part of an earring allows the attachment of any component of an earpiece or related device to the earring or part of the earring such that the earpiece is retained in, on, or near the ear of the wearer despite movement of the head. This combination is ideal since most women (and some men) wear earrings and use earpieces simultaneously. FIG. 1 shows the overall principle and demonstrates one embodiment of the invention. Here a cable (wire) from an earpiece is held in a curved (e.g. semi-circular) channel in the side of a stud earring designed for pierced ears. Earpieces tend to fall out of the ear for principally two reasons: (1) the earpiece itself loosens its seating in the concha of the ear through movement of the head (this may be exacerbated by perfume, lotion, sweat, etc.) and (2) inadvertent tugging or pulling of the cable (or even the weight of the cable itself) serves to lever the earpiece out of the ear as the user moves. The current invention addresses successfully both of these issues: in the embodiment of FIG. 1, the earring helps to anchor the earpiece in the concha of the ear through a semi-rigid attachment of the cable to the earring (thus also ensuring good auditory quality). Furthermore, since the cable of the earpiece is now firmly attached to the ear through the earring, the weight of the cable will no longer tend to loosen the earpiece during movement of the user, thus minimizing the possibility of the earpiece dislodging from the ear. In addition, use of the invention mitigates the effects of minor touching of or pulling on the cable which should now not cause the earpiece to dislodge from the ear.

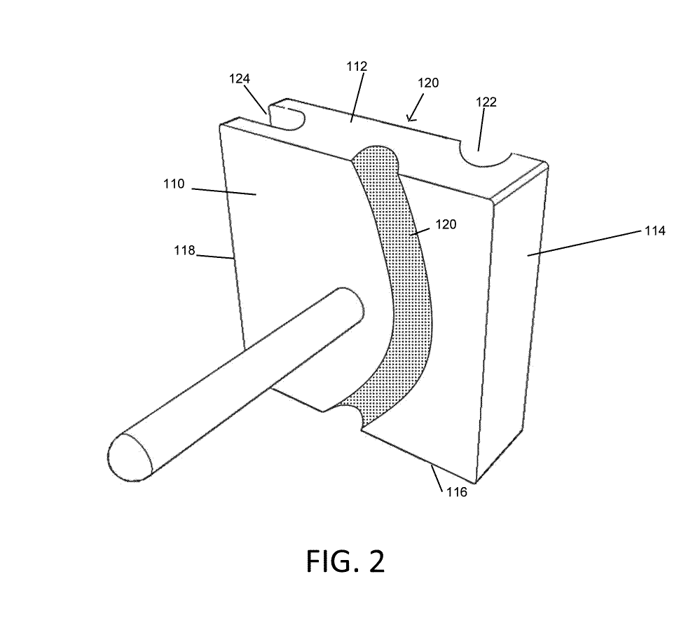

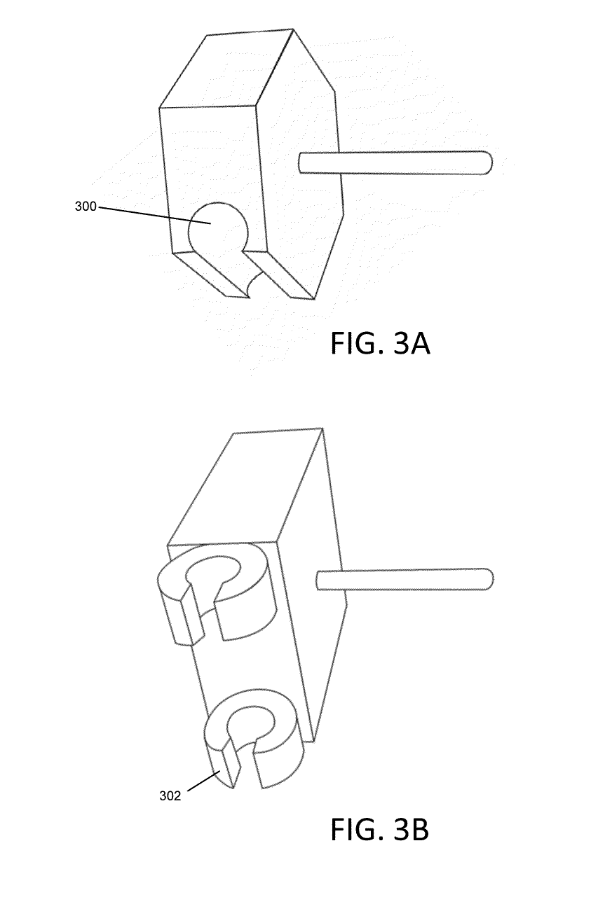

In the embodiment of FIG. 1, such a channel may be of any length covering either partially or fully the length or breadth of the earring, may be of any cross-sectional shape (for example, square, rounded, partially closed, “V”, asymmetric, etc. or combinations thereof), and may be straight, bent, curved, etc. (or any combinations thereof). The surface of the channel may be smooth, textured, and/or contain features designed to enhance the retention of the cable in the channel (for example, similar to a “clam cleat”). Each earring may contain one or more such attachment points as shown, for example, in FIG. 2 and these attachment points may be on any face of the earring including, but not limited to, the front, side, and/or rear of the earring. Such attachment points may be integral to the earring (as shown in FIG. 3A) or external to the body of the earring (as shown in FIG. 3B).

The attachment of the component of the earpiece to the earring may be rigid, semi-rigid, flexible or a combination thereof. While many of the embodiments discussed above use slots or channels in the earring to partially encase the cable from an earpiece, the current invention is not limited solely to this concept. Attachment may be made to any portion of the earpiece including the housing, the ear tips, the wire (or cable) guide, the wire (or cable), the plug, etc. and the means of attachment may contain channels, slots, grooves, rigid clamps, movable clamps, clips, straps, snaps, Velcro, pins, posts, cleats, apertures, holes, ties, bands, adhesives, etc. and combinations thereof.

With reference to the Figures, the present invention provides an apparatus (100) for securing an earpiece having a cable (102), the apparatus comprising: an earring having an attachment portion (104) and a base portion (106). The base portion has a channel (108) that runs a length of the base portion (106) and is curved, e.g. semi-circular, in shape to receive a portion of a cable (102) of an earpiece. This is depicted FIGS. 1A, 1B and 1C. The base portion, as shown in FIG. 2, may have a top side (not shown but pointed to at 120 and opposing bottom side 110), a bottom side (110), upper edge (112), left edge (114), right edge (118) and bottom edge (116). As depicted, the channel(s) may be in at least one of the top side, the bottom side, the upper edge, the left edge, the right edge and the bottom edge. Also, as shown, the channel (e.g. 120, 122, 124) may be in any combination of the top side (120), the bottom side (110), the upper edge (112), the left edge (114), the right edge (118) and the bottom edge (116).

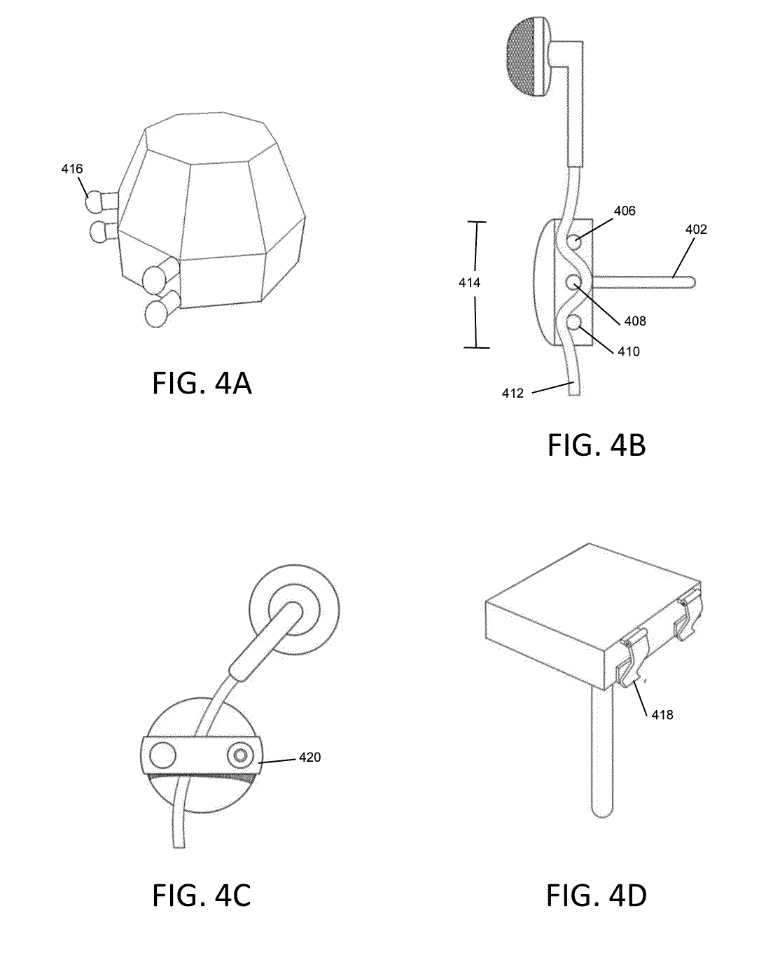

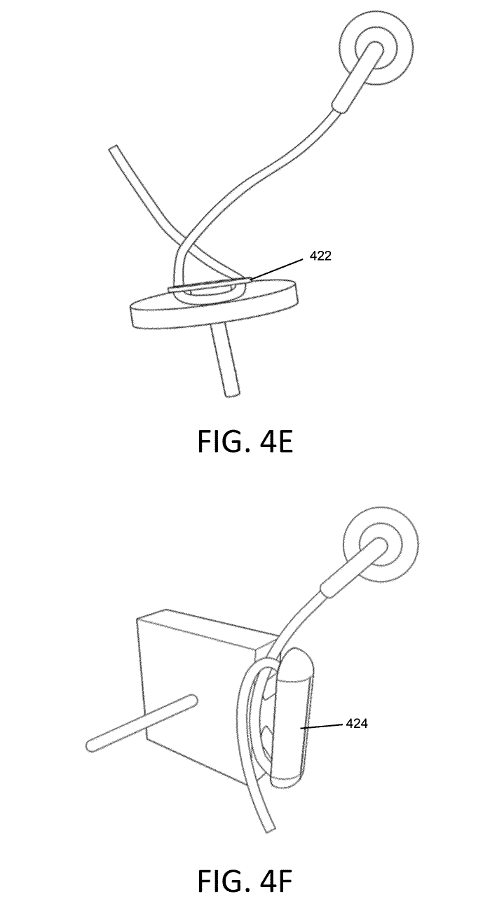

FIG. 4 shows multiple different embodiments of the invention for the attachment of a cable to an earring. These include one or more posts or pins in which to contain the cable (4A), offset posts or pins (4B), a strap and snap (4C), movable clamps (4D), a short post with flat top (4E), and a cleat (4F). Those skilled in the art will note that the attachment point(s) may be on any face or on any part of the earring and may attach to any component of the earpiece including, but not limited to the housing, the ear tips, the wire (or cable) guide, the cable (wire), the plug, etc. The attachment portion may be constructed from one or multiple pieces which are either separate or affixed to the earring. The cable (if used as the attachment component) may remain approximately straight, bent or wound around a fixture. The attachment portion may be either permanently affixed to the earpiece (or component of the earpiece) or be removable. Similarly, the earring may be permanently affixed to the ear or be removable.

The invention disclosed herein considers all types of materials and combinations of materials, textures, and finishing processes that are used currently in the construction of earrings. These include, but are not limited to, metals, synthetic and natural polymers, plastics and rubbers, ceramics (both natural and manmade), wood, glass, stones, gems, minerals, natural products (such as, for example, feather, fur, bone, shell), etc. and combinations thereof. Earrings may be of single or multiple pieces, each of which may be rigid, semi-rigid, or flexible or a combination thereof and may be cast, cut, formed, pressed, extruded, glued/adhered, stamped, tooled, set, pegged, soldered, manipulated, wire wrapped, assembled, etc.

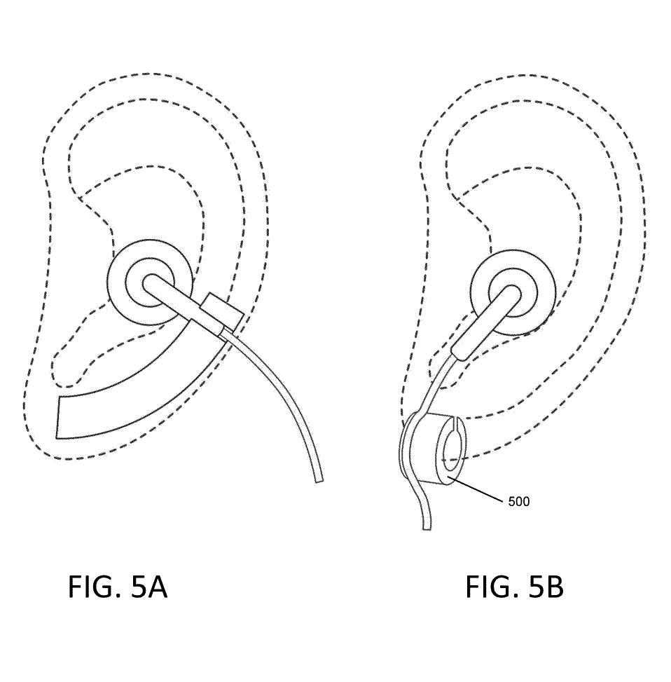

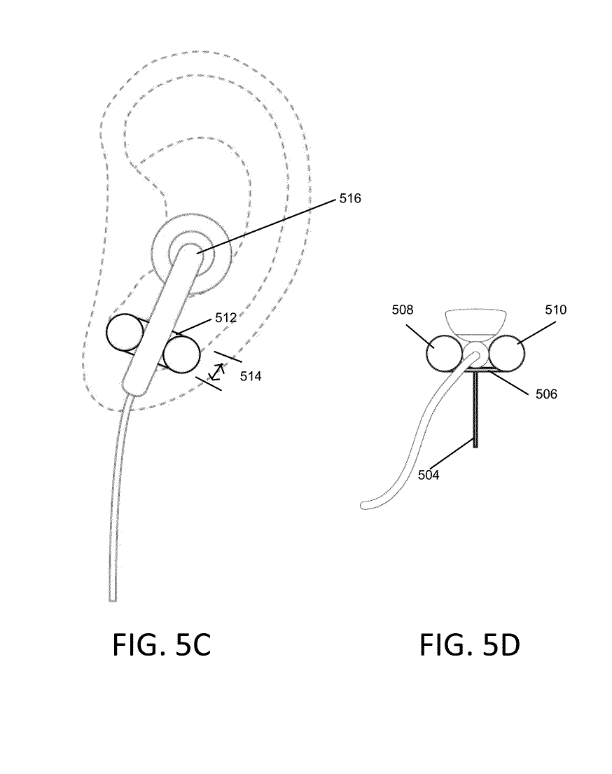

Depending on the comfort, style, and needs of the wearer, earrings may be either semi-rigidly attached to the ear such as in the embodiment shown by the “crawling” earring in FIG. 5A or more loosely attached to the ear as shown by the cuff earring in FIG. 5B. In FIG. 5A the attachment is directly to the cable (wire) guide of the earpiece through a channel in the earring while in FIG. 5B the connection is to the cable. An intermediate case is shown by the barbell earring in FIG. 5C (end view in FIG. 5D). Here the earring is attached to the wire guide of an earpiece and because the barbell can rotate, the earring is “self-aligning” with respect to the angle of the wire guide. The apparatus (502) for securing an earpiece having a cable, as shown, is an earring having an attachment portion (504) and a base portion (506), wherein the base portion (506) has at least two raised portions (508 and 510) that create a center opening (512) that runs a length (514) of the base portion (504) to receive a portion of an earpiece (516). Any portion of the earpiece may be received in the center opening. For example, the cable, earbud, ear tip, plug and any combination thereof may be received in the center opening. It is also envisioned that the at least two raised portions may take any shaped (for example, rectangular, circular, triangular, oval, etc. According to the embodiment depicted, the at least two raised portions (508 and 510) are circular shaped.

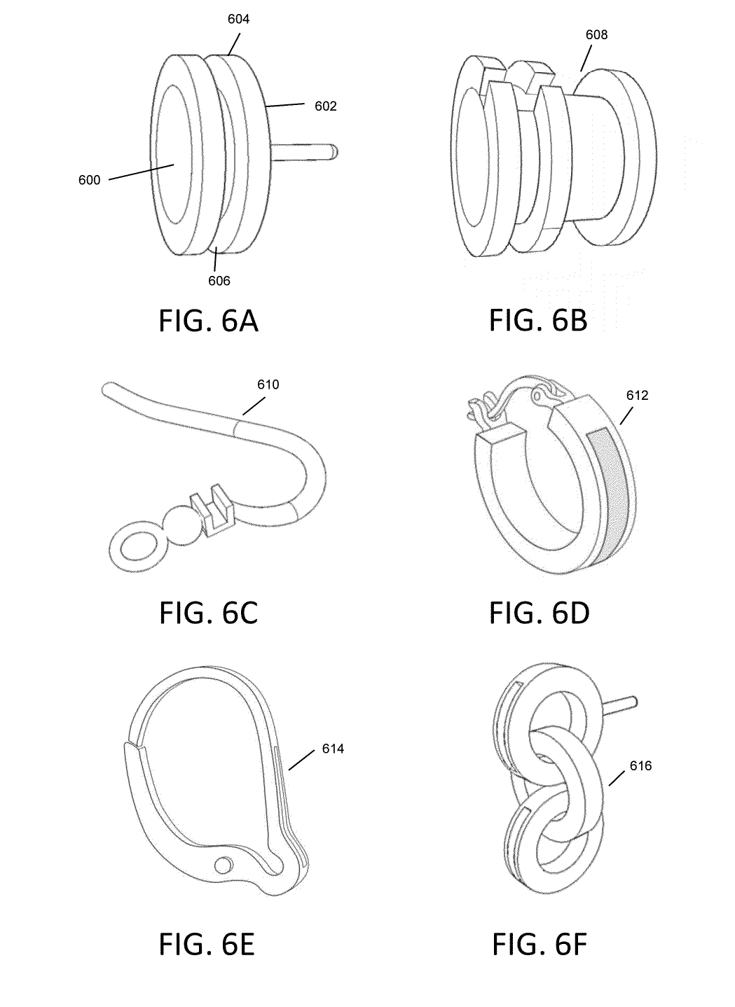

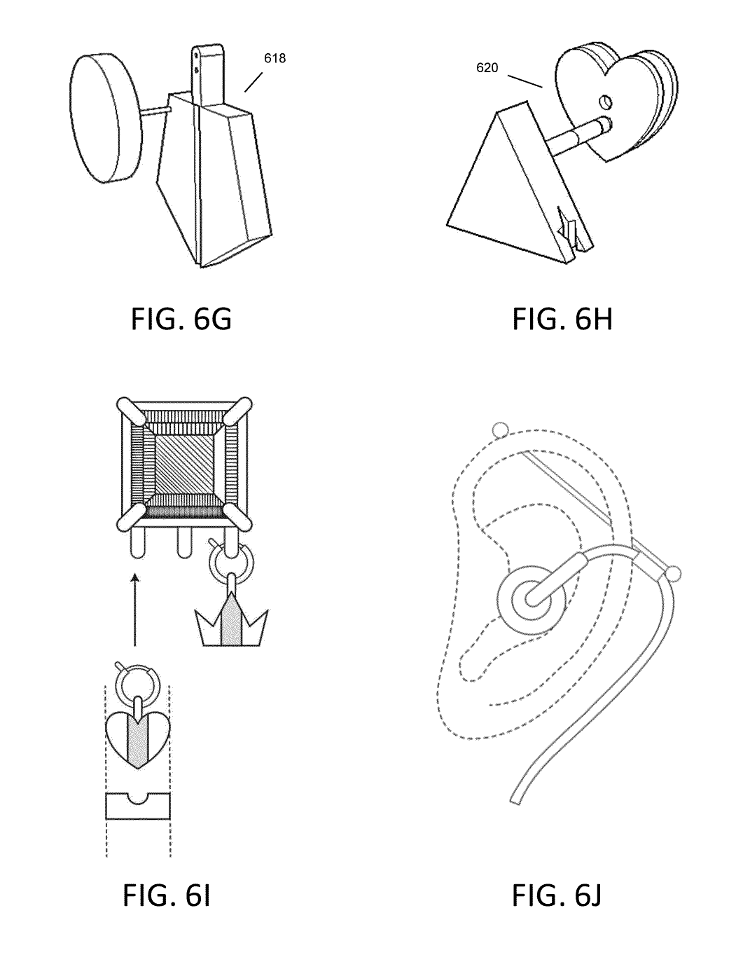

Many additional embodiments of the invention for users with pierced ears are shown in FIG. 6. These have varying rigidity in their connection to the ear and include a faux gauge earring (6A), a gauge earring (6B), an ear wire (6C), a hoop earring (6D), a lever-back earring (6E), a linked earring (6F), an ear jacket earring (6G), a reversible earring with decorative channels in both the front and back parts (6H), a chandelier earring with connection points either on the base, on the detachable “charms,” or both (6I), and an industrial earring (6J). In these embodiments, each has one or more channels for the attachment of a cable from an earpiece.

As shown in FIG. 6A, the base portion may also be circular shaped having a circular top side (600), a circular bottom side (602) and an outside edge (604). The channel (606) may run the entire circumference of the base portion, or a portion of the circumference. The channel may also be in at least one of the circular top side (600), the circular bottom side (602) and the outside edge (604).

As shown in FIG. 3A, the channel may be between 185 and 355, more preferably between 260 and 320 degrees of a circle. It should be understood that the channel may take many forms, for example, as shown in FIG. 2, channel 122 is a half circle and channel 124 is a half oblong oval shape. The attachment portion may be selected from the group consisting of a piercing stud (e.g. 104), clip-on (e.g. 700), cuff (500), magnetic (702), stick-on (704), reversible (e.g. 620), gauge (608), and a combination thereof.

The present invention also provides an apparatus for securing an earpiece having a cable, the apparatus comprising: an earring having an attachment portion (402) and a base portion (400) having at least one extension (e.g. 406, 408 and 410), wherein the extension receives a portion of a cable (412) of an earpiece to align the cable to run a length (414) of the base portion (400) that is away from the attachment portion (412). The extension may be pin head shaped (416), semi-circular (302), folding clip shaped (418), clip shaped (420), T-shaped (422), double legged T-shaped (424) and/or channel shaped. The attachment portion may be a piercing stud (e.g. 104), clip-on (e.g. 700), cuff (500), magnetic (702), stick-on (704), reversible (e.g. 620), gauge (608), and a combination thereof.

According to another aspect of the present invention, an apparatus for securing an earpiece having a cable is provided, the apparatus comprising: an earring having a piercing stud portion, an earring backing (810) that removably attaches to the piercing stud portion and a base portion, wherein the earring backing (810) has a first circular side (800) with an opening (802) to receive a portion of a cable of an earpiece therein, a second circular side (804) and a bore (806) between the first circular side (800) and second circular side (804) to attach the earring backing to the piercing stud portion.

According to another aspect of the present invention, an apparatus for securing an earpiece having a cable is provided, the apparatus comprising: an earring having a piercing stud portion, an earring backing that removably attaches to the piercing stud portion and a base portion; and a cable receiving portion (822) designed to receive a portion of a cable of an earpiece therein and a bore (824) to attach the cable receiving portion to the piercing stud portion (826) between the base portion (828) and the earring backing (830). The cable receiving portion may be selected from the group consisting of channel, slot, groove, rigid clamp, movable clamp, clip, strap, snap, Velcro, pin, post, cleat, aperture, hole, tie, band, and a combination thereof.

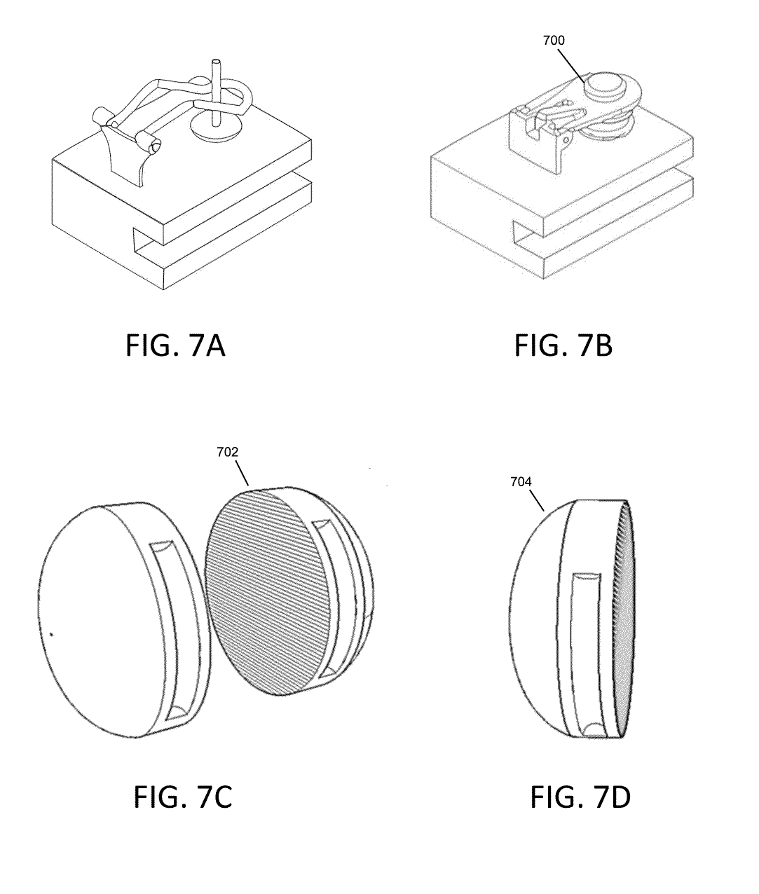

The current invention is not limited to earrings for pierced ears and includes all variations of earring mounting options, constructed from all conventional materials and combinations thereof, and connected to one or more components of an earpiece. Some, but not all, of these embodiments are illustrated in FIG. 7 for a square cross-section channel designed to attach to the cable of an earpiece. These include: a pierced and clip earring (7A), a clip-on earring (7B), a magnetic earring (7C), and a stick-on earring (7D). Earrings may be used singly in either the right or left ear or in pairs to allow attachment to earpieces in both ears. Such earrings need not match. Furthermore, users may desire to wear multiple types and/or sizes of earrings with multiple attachment points on a single ear.

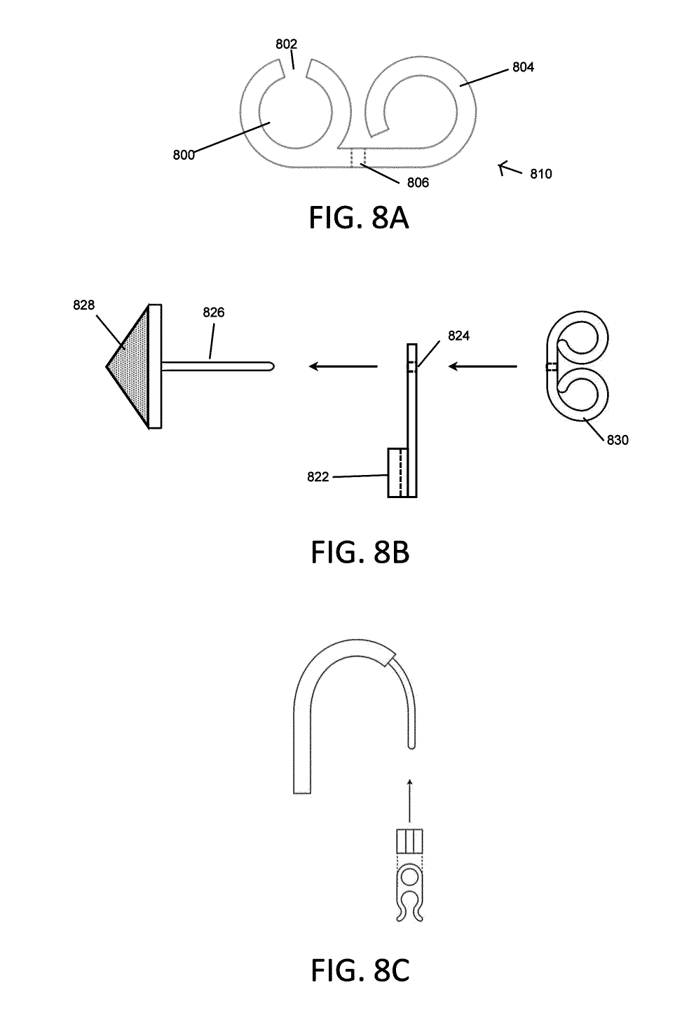

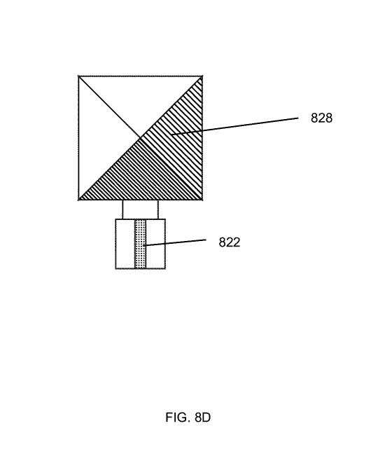

The current invention does not limit the attachment of the earpiece solely to the earring itself and may include attachment to a detachable earring part. Examples include, but are not limited to, a charm reversibly attached to an earring as shown in FIG. 6I or the backing of an earring for a pierced ear containing a slot for the cable from an earpiece as shown in FIG. 8A. It should be clear to one skilled in the art that such charms or earring backs may be used with conventional earrings, constructed from all conventional materials and combinations thereof, and connected to one or more components of an earpiece.

An additional embodiment of the invention used in conjunction with a conventional earring for a pierced ear is shown in FIG. 8B and FIG. 8D. Here an earpiece cable support is separate from the earring and the earring back and may be worn either in front of the ear (between a conventional earring and the ear) or behind the ear (between the ear and a conventional earring back). Attachment to either the earring or the earring back may be permanent or reversible. This embodiment of the invention is not limited to stud earrings as shown by the example in FIG. 8C. Here a support for the cable from an earpiece either slides onto or clips onto the wire of an ear wire-style earring. Those skilled in the art will note that the connection between the support and the cable from the earpiece may be permanent or removable.

Note that extensive wearing of earpieces by some users may lead to enhanced sensitivity to certain portions of the ear, including the tragus and the anti-tragus. Those users will further appreciate the comfort afforded by the invention since the weight of the earpiece and/or the cable from the earpiece may now be supported at least in part by the ear lobe, helix, and/or scapha of the ear.

From time to time, the user of earpieces may also desire to hear external sounds more clearly. Thus, if earpieces are attached to earrings, for example, through a cable, the user may simply remove one or more earpiece either fully or partially from the ear and allows it to “hang” from the earring. This improves the accessibility of the earpieces to the ear by allowing the user ready access to the earpiece without the inconvenience of holding, tying, wearing around the neck, placing in a pocket or purse, etc. when wants to use it/them again. Note that each earring may be considered a “fashion statement” and need not be removed if earpieces are not in use.

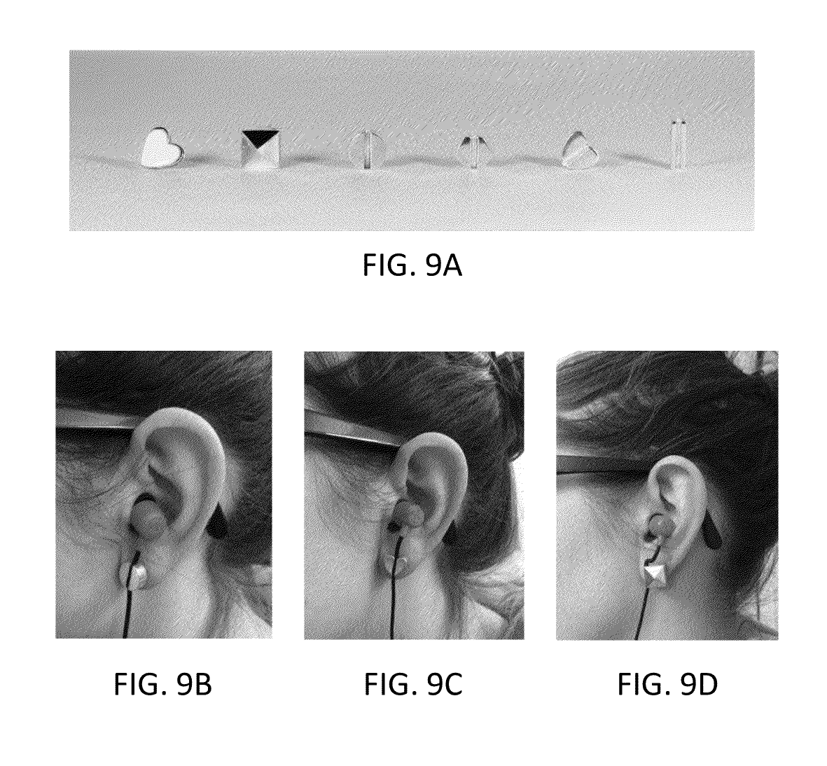

The invention disclosed above is not an abstract concept, but has been reduced to practice as shown by the photographs in FIG. 9. FIG. 9A is a photograph of six embodiments of the invention. FIGS. 9B, 9C, and 9D are a series of photographs showing how the earring is used by the wearer. These include a nail head stud (9B), a heart stud (9C), and a pyramid stud (9D) with the cable from the earpiece connected through a channel in the front (9B and 9C) or side (9D) of the earring. Wear testing indeed shows that the even during strenuous exercise or when the cable is inadvertently pulled, the earpiece remains comfortably in the ear.

It should be understood that the foregoing relates to preferred embodiments of the invention and that modifications may be made without departing from the spirit and scope of the invention as set forth in the following claims.

We claim:

1. An apparatus for securing an earpiece having a cable, the apparatus comprising:
an earring having an attachment portion and a base portion, wherein the base portion has a channel that runs a length of the base portion to receive a portion of an earpiece.

2. An apparatus as in claim 1, wherein the base portion has a top side, a bottom side, upper edge, left edge, right edge and bottom edge.

3. An apparatus as in claim 2, wherein the channel is in at least one of the top side, the bottom side, the upper edge, the left edge, the right edge and the bottom edge.

4. An apparatus as in claim 1, wherein the base portion is a curved shape having a curved top side, a curved bottom side and an outside edge.

5. An apparatus as in claim 4, wherein the opening is in at least one of the curved top side, the curved bottom side and the outside edge.

6. An apparatus as in claim 1, wherein the channel is between 185 and 355 degrees of a circle.

7. An apparatus as in claim 1, wherein the attachment portion is selected from the group consisting of a piercing stud, clip-on, cuff, magnetic, stick-on, reversible, gauge, and a combination thereof.

8. An apparatus as in claim 1, wherein the portion of the earpiece that is received in the channel is selected from the group consisting of the cable, cable wire, cable guide, cable wire guide, earbud, ear tip, plug and a combination thereof.

9. An apparatus for securing an earpiece having a cable, said apparatus comprising:
an earring having an attachment portion and a base portion having at least one extension, wherein the extension receives a portion of a cable of an earpiece to align the cable to run a length of the base portion that is away from the attachment portion.

10. An apparatus as in claim 9, wherein the base portion has a top side, a bottom side, upper edge, left edge, right edge and bottom edge.

11. An apparatus as in claim 9, wherein the base portion is curved shape having a curved top side, a curved bottom side and an outside edge.

12. An apparatus as in claim 9, wherein at least one extension is selected from the group consisting of pin head shaped, semi-circular, folding clip shaped, clip shaped, T-shaped, double legged T-shaped, channel shaped.

13. An apparatus as in claim 9, wherein the receiving portion is selected from the group consisting of channel, slot, groove, rigid clamp, movable clamp, clip, strap, snap, Velcro, pin, post, cleat, aperture, hole, tie, band, and a combination thereof.

14. An apparatus as in claim 9, wherein the attachment portion is selected from the group consisting of a piercing stud, clip-on, cuff, magnetic, stick-on, reversible, gauge, and a combination thereof.

15. An apparatus for securing an earpiece having a cable, the apparatus comprising:
an earring having a piercing stud portion, an earring backing that removably attaches to the piercing stud portion and a base portion, wherein the earring backing has a first circular side with an opening to receive a portion of a cable of an earpiece therein, a second circular side and a bore between the first circular side and second circular side to attach the earring backing to the piercing stud portion.

16. An apparatus as in claim 15, wherein the receiving portion is selected from the group consisting of channel, slot, groove, rigid clamp, movable clamp, clip, strap, snap, Velcro, pin, post, cleat, aperture, hole, tie, band, and a combination thereof.

17. An apparatus for securing an earpiece having a cable, the apparatus comprising:
an earring having a piercing stud portion, an earring backing that removably attaches to the piercing stud portion and a base portion; and
a cable receiving portion with an opening to receive a portion of a cable of an earpiece therein and a bore to attach the cable receiving portion to the piercing stud portion between the base portion and the earring backing.

18. An apparatus for securing an earpiece having a cable, the apparatus comprising:
an earring having an attachment portion and a base portion, wherein the base portion has at least two raised portions that create an opening to receive a portion of an earpiece.

19. An apparatus as in claim 18, wherein the attachment portion is selected from the group consisting of a piercing stud, clip-on, cuff, magnetic, stick-on, reversible, gauge, and a combination thereof.

20. An apparatus as in claim 18, wherein the portion of the earpiece that is received in the opening is selected from the group consisting of the cable, cable wire, cable guide, cable wire guide, earbud, ear tip, plug and a combination thereof.

21. An apparatus as in claim 18, wherein the at least two raised portions are circular shaped.
